(19) United States
(12) Patent Application Publication
(10) Pub. No.: US 2007/0117703 A1
(43) Pub. Date: May 24, 2007

(54) Machine and method for converting a web of material into dunnage

(75) Inventors: Vincent Cavaliere JR., Monroe, CT (US); Alexander Shafir, Watertown, CT (US)

Correspondence Address: Thomas C. Lagaly;Sealed Air Corporation, P.O. Box 464, Duncan, SC, 29334, US

(73) Assignee: Sealed Air Corporation

(21) Appl. No.: 11/285,246

(22) Filed: Nov. 22, 2005

(51) Int. Cl. B31B 1/00

(52) U.S. Cl. 493/464

(57) ABSTRACT

A machine and method for converting a web of material into dunnage, the machine comprising a mechanism for conveying the web through the machine, a first web-shaping device for crumpling the web, a second web-shaping device for further crumpling the web, and a severing mechanism to sever the web into discrete lengths.

### BACKGROUND OF THE INVENTION

The present invention relates generally to packaging materials and, more specifically, to a machine and method for making dunnage.

Dunnage is a type of packaging material that is used primarily to fill void spaces between an item and a container, e.g., a carton or box, in which the item is to be shipped. By filling such void spaces, the dunnage material prevents the item from moving around within the container during shipment, or at least reduces any such movement. Dunnage may also provide a degree of cushioning protection to the packaged item. Examples of dunnage materials include loose-fill ‘peanuts’ (i.e., expanded polystyrene particles), air-filled bags, and crumpled webs of material, particularly paper. The present invention is directed to a method and machine for making dunnage by crumpling a web of material.

Many types of machines exist for converting a web of material, such as paper, into dunnage. Such machines, however, tend to be rather expensive and complex.

Accordingly, there is a need in the art for a simpler and less expensive machine and method for producing dunnage from a web of material.

### SUMMARY OF THE INVENTION

That need is met by the present invention, which, in one aspect, provides a machine for converting a web of material into dunnage, the machine comprising:

a) a mechanism for conveying the web through the machine;

b) a first web-shaping device for crumpling the web;

c) a second web-shaping device for further crumpling the web; and

d) a severing mechanism to sever the web into discrete lengths.

In one embodiment, the second web-shaping device comprises a three-dimensional, annular member having a passage therein through which the web may travel, the annular structure having a web-contact region bordering the passage, wherein the web-contact region comprises a curved surface and provides sliding contact with the web to effect the further crumpling thereof.

In another embodiment, the second web-shaping device comprises a generally toroidal-shaped structure having a passage therein through which the web may travel, the generally toriodal-shaped structure having a web-contact region bordering the passage, wherein the web-contact region provides sliding contact with the web to effect the further crumpling thereof.

Another aspect of the invention pertains to a method for converting a web of material into dunnage, the method comprising:

a) crumpling the web in a first web-shaping device;

b) further crumpling the web in a second web-shaping device, the second web-shaping device comprising one of the two embodiments as described immediately above;

c) conveying the web through the first and second web-shaping devices; and

d) severing the web into discrete lengths.

These and other aspects and features of the invention may be better understood with reference to the following description and accompanying drawings.

### BRIEF DESCRIPTION OF THE DRAWING

FIG. 1 is a schematic view of a machine and method for converting a web of material into dunnage in accordance with the present invention;

FIG. 2 is a plan view of the schematic illustration shown in FIG. 1;

FIG. 3 is similar to FIG. 1, but shows the converted web being severed into a discrete length for placement into a shipping container;

FIG. 4 is a perspective view of one of the web-shaping devices shown in FIGS. 1-3;

FIG. 5 is a perspective view of a working embodiment of a dunnage machine in accordance with the present invention, showing a web of material being fed into the machine;

FIG. 6 is a frontal elevational view of the machine shown in FIG. 5;

FIG. 7 is a partial perspective view of the machine illustrated in FIG. 5, wherein a trailing end of the web is shown protruding from the second web-shaping device;

FIG. 8 is a plan view of the machine shown in FIG. 5, wherein the outer cover has been removed;

FIG. 9 is another perspective view of the machine shown in FIG. 5, but of the other side and exit end of the machine, i.e., as viewed from a position 180 degrees removed from the perspective shown in FIG. 5, and with the outer cover removed;

FIG. 10 is a sectional view of the web-shaping device shown in FIG. 4, taken along lines 10-10 and illustrating the circular cross-sectional shape of the device;

FIG. 11 is similar to FIG. 10, except that a semi-circular cross-sectional shape of an alternative web-shaping device is illustrated;

FIG. 12 is similar to FIG. 10, except that an elliptical cross-sectional shape of a further alternative web-shaping device is illustrated;

FIG. 13 is similar to FIG. 10, except that a semi-elliptical cross-sectional shape of another alternative web-shaping device is illustrated; and

FIG. 14 is a cross-sectional view of web-shaping 18′ and mounting plate 62, taken along lines 14-14 in FIG. 8.

### DETAILED DESCRIPTION OF THE INVENTION

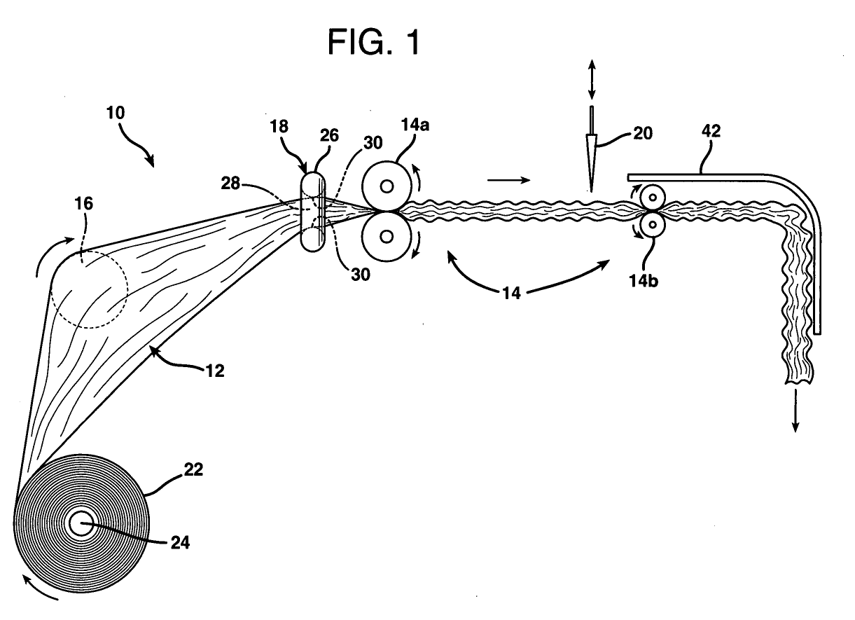

FIGS. 1-3 schematically illustrate a machine 10 in accordance with the present invention for converting a web 12 into dunnage. Web 12 may comprise any type of material capable of conversion into dunnage, including paper, e.g., kraft paper; thermoplastic film; recycled plastic; etc.

Machine 10 includes a mechanism 14 for conveying the web through the machine, a first web-shaping device 16 for crumpling the web, a second web-shaping device 18 for further crumpling the web, and a severing mechanism 20 to sever the web into discrete lengths. As shown, conveyance mechanism 14 may include a first pair 14a of counter-rotating drive members and, if desired, a second pair 14b of counter-rotating drive members positioned downstream of the first pair 14a. Drive member pairs 14a and 14b may be driven at the same speed or at different speeds as desired, e.g., to create tension or compression in the section of web 12 between the drive member pairs. Further, the drive member pairs 14a, b may be driven simultaneously or at different intervals, which may overlap as desired. The drive members may comprise a pair of counter-rotating drive rollers as illustrated. One or both drive roller pairs may be in contact with one another as shown, or may have a gap therebetween, depending, e.g., on the desired thickness of the dunnage product, the material of web 12, etc. When drive member pairs 14a, b are in the form of drive rollers, the rollers may comprise any material suitable for conveying web 12, such as metal (e.g., aluminum, steel, etc.), rubber, elastomer (e.g., RTV silicone), urethane, etc., including combinations of the foregoing materials. For example, one pair of drive rollers could be constructed from metal while the other pair could be made from a polymeric material or a metal/polymer composite material, e.g., a metal core with a polymeric outer/web-contact peripheral surface. Alternatively, within a drive member pair, one drive member may be metallic while the other is polymeric or at least has a polymeric web-contact/peripheral surface.

As an alternative to drive rollers, the drive members may comprise a pair of counter-rotating drive belts, drive bands, or any suitable mechanism for conveying a web.

As illustrated, severing mechanism 20 may be positioned between first pair 14a and second pair 14b of drive members. Such a configuration isolates the severing mechanism, thereby reducing the likelihood that an operator of machine 10 will place a hand in contact with the severing mechanism while the machine is operating. This configuration may also facilitate severance of the web, as described below.

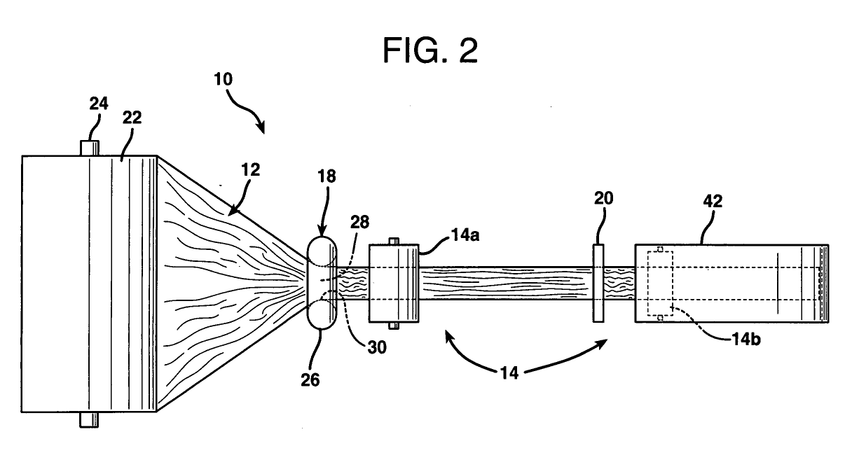

Web 12 may be supplied from a roll 22 as illustrated, or from any convenient means of storage and dispensation, e.g., from a fan-folded stack contained in a carton. When in the form of a roll 22, the roll may be wound on, and unwound from, a spool 24 as shown in FIG. 2.

First web-shaping device 16 may be positioned upstream of second web-shaping device 18 as shown, and may comprise any device that changes the shape of web 12, e.g., from a generally planar form to one that is more three-dimensional, i.e., crumpled. For example, the first web-shaping device 16 may simply cause web 12 to at least partially fold upon itself as shown. First web-shaping device 16 may comprise a frame, bar, or other non-moving device that causes the web to crumple, e.g., fold. Alternatively, first web-shaping device 16 may comprise a movable device, such as one or more rotatable cylinders, paddlewheels, gears, etc. As shown, first web-shaping device 16 is in the form of a rotatable wheel, which may passively rotate when the web makes contact therewith in such a manner that the web folds upon itself in a generally longitudinal fashion, i.e., along the general longitudinal direction of web travel.

As shown, web 12 may move through machine 10 along a defined path of travel. If desired, the first web-shaping device 16 may cause the web to change direction along its travel path. For example, the first web-shaping device 16 may cause the web to change from a generally vertical direction of movement to a generally horizontal direction of movement as shown.

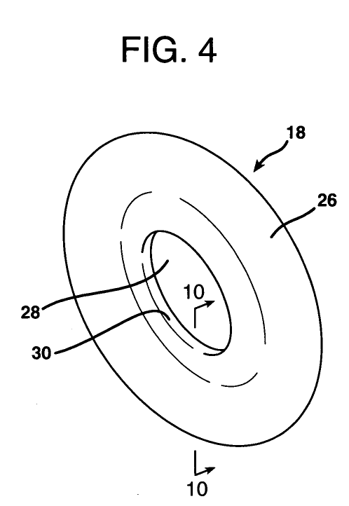

As shown perhaps most clearly in FIG. 4, second web-shaping device 18 may comprise a three-dimensional, generally annular member 26, with a passage 28 therein through which the web 12 may travel. A web-contact region 30 borders the passage 28. Web-contact region 30 may comprise a curved surface, e.g., a continuously curved surface as shown, and provide sliding contact with the web to effect the further crumpling thereof. A curved surface for web-contact region 30 may reduce the likelihood that web 12 will be ripped, torn, shredded, or otherwise damaged as it slides against web-contact region 30 while traversing passage 28.

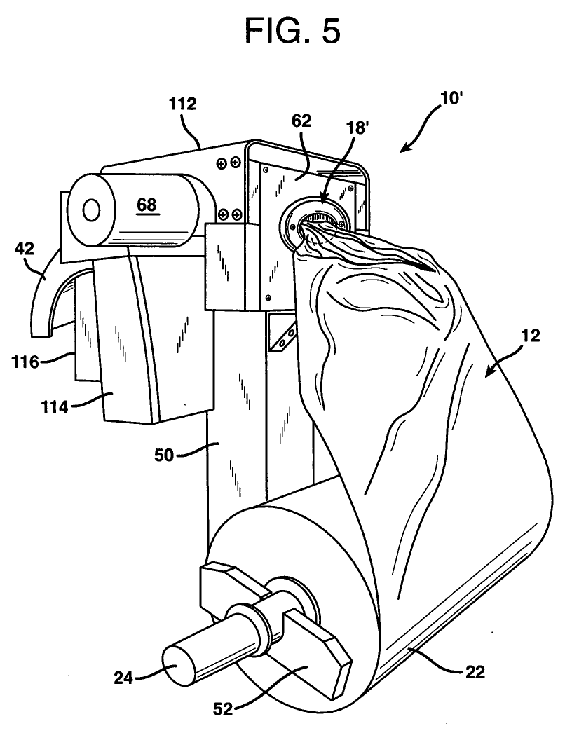

In some embodiments, second web-shaping device 18 may have a shape which may be described as being substantially toroidal, i.e., generally ring-shaped. For example, second web-shaping device 18 may have a substantially round toroidal shape, e.g., a shape that resembles a doughnut, as shown by annular member 26 in FIGS. 1-4. Alternatively, second web-shaping device 18 may have a substantially elliptical or oval toroidal shape, e.g., as shown in the embodiments illustrated in FIGS. 5-9.

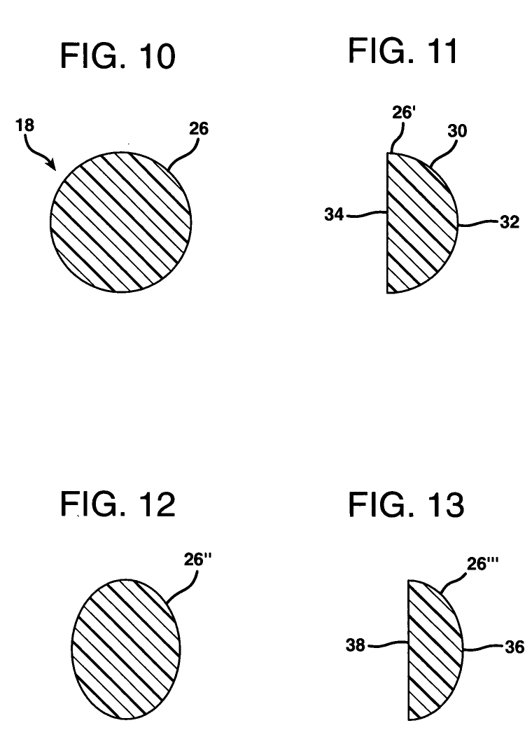

In addition to selecting the overall shape of second web-shaping device 18 as described above, the cross-sectional shape of the annular member from which the second web-shaping device is constructed may also be selected. For example, annular member 26, as depicted in FIGS. 1-4, may have a circular cross-sectional shape as shown in FIG. 10. Alternatively, the annular member could have a semi-circular shape as shown in FIG. 11, wherein such annular member is designated 26′. In this embodiment, annular member 26′ may advantageously be deployed such that the curved side 32 faces upstream to form the web-contact region 30. As such, the flat side 34 may form a downstream-facing, non-web-contact region. As will be discussed below, the second web-shaping device 18′ illustrated in FIGS. 5-9 has an annular member with a generally semi-circular cross-sectional shape, similar to annular member 26′ as shown in FIG. 11.

A further alternative cross-sectional shape for the annular member of the second web-shaping device 18 is shown in FIG. 12, wherein annular member 26″ has an elliptical cross-sectional shape. In FIG. 13, another alternative is shown, wherein annular member 26′″ has a semi-elliptical cross-sectional shape. With this embodiment, the curved side 36 of annular member 26′″ may face upstream to form the web-contact region while flat side 38 may form a downstream-facing, non-web-contact region. As will be discussed below, the second web-shaping device illustrated in FIGS. 5-9 has an annular member 26′″ with a semi-elliptical cross-sectional shape as shown in FIG. 13.

The second web-shaping device 18 generally effects the further crumpling of the web, i.e., further to the crumpling provided by the first web-shaping device 16, by forcing the web to continue to collapse upon itself as it is conveyed through passage 28, wherein such further collapse is brought about by the sliding contact between the web 12 and web contact region 30. That is, the shape of and size of passage 28 is constrained relative to the shape and size of the web 12 entering the second web-shaping device 18 so that, in order to go through passage 28, the web must conform its cross-sectional shape and size to approximate that of passage 28. The size, i.e., area, of passage 28 may be selected relative to the initial width of web 12 such that a desired amount of crumpling is achieved, with a smaller area for passage 28 leading to a greater degree of crumpling.

Second web-shaping device 18 may be constructed from any material that permits sliding contact between the device 18 and web 12 without significantly tearing or otherwise damaging web 12 as it is conveyed through device 18, e.g., a material that provides minimal frictional resistance to the movement of the web through device 18, which may be indicated by a material having a low coefficient of friction (“COF”). Ideally, such a material would also be one that is resistant to wear as caused by the movement of web 12 there against. Many suitable materials exist; examples include polymeric materials such as ultra-high molecular weight polyethylene (UHMWPE), polyimide, fluorocarbon resins such as polytetrafluoroethylene (PTFE) and perfluoropropylene, acetal resins, i.e., resins based on polyoxymethylene, including homopolymers (e.g., Delrine® brand polyoxymethylene), copolymers, and filled/impregnated grades, such as PTFE-filled acetal resins; various metals such as aluminum, steel, etc.; metals with low-COF coatings, e.g., anodized aluminum or nickel impregnated with low-COF polymers such as PTFE or other fluorocarbon resins; and mixtures or combinations of the foregoing.

Machine 10 may include an exit chute 42 which may, as illustrated, cause web 12 to change direction along its travel path, e.g., from a generally horizontal direction of movement to a generally vertical direction of movement as shown. In addition to providing a safety function, this feature may also be employed to direct severed web segments to a desired location, e.g., into a packaging container.

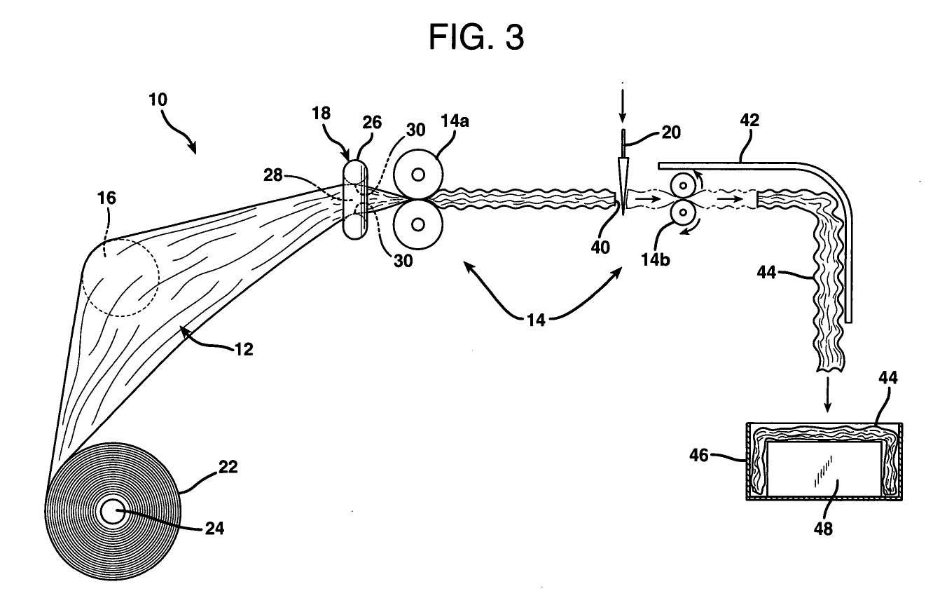

For example, as illustrated in FIG. 3, severed lengths of web 12, which have been converted into dunnage segments 44 and cut to a desired length by severing mechanism 20, are directed into shipping container 46 by exit chute 42, wherein the dunnage segments 44 will be used to protect item 48 during shipment in container 46.

Severing mechanism 20 may comprise any conventional web-severing device suitable to sever web 12. For example, when web 12 comprises a thermoplastic material, severing mechanism 20 may include a heated severing element to sever the web by melting through it. Suitable heated severing elements may include heatable wires, blades, bands, etc. As another example, particularly when web 12 comprises paper, paperboard, or other fibrous material, severing mechanism 20 may include a cutting blade, such as a rotary blade; a swinging blade; a reciprocating blade, e.g., ‘guillotine-type’ device; a pair of blades, wherein at least one moves relative to the other; etc.

With continuing reference to FIGS. 1-3, a method for converting web 12 into dunnage 34 will be described. In accordance with some methods, web 12 is crumpled by first web-shaping device 16, and then further crumpled by second web-shaping device 18 as described above. Conveyance mechanism 14, which may include first and second pairs of drive members 14a, b as shown, pulls the web over the first web-shaping device 16 and through the second web-shaping device 18 as shown in FIG. 1. When a desired amount of crumpled web has been conveyed past the second pair of drive members 14b, severing device 20 may be activated to severe the web into a discrete length of dunnage 44, as shown in FIG. 3.

First and second pairs of drive members 14a, b may be operated by separate power sources, e.g., motors, or by the same motors with appropriate linkage, and may be operated at the same speed or a different speed. In some embodiments, separate motors may be used to operate each pair 14a, b of drive members, but pair 14b may be ‘slaved’ to pair 14a by applying more force to drive member pair 14a than to drive member pair 14b, e.g., by employing a more powerful motor for pair 14a and/or through the use of different gearing so that more torque is applied to drive member pair 14a than to drive member pair 14b.

By ‘slaving’ pair 14b to pair 14a in this manner, both pairs will rotate at the same speed while conveying web 12 as shown in FIG. 1. When it is desired to sever the web as in FIG. 3, power to drive member pair 14a may be halted while power to drive member pair 14b continues to be supplied. The power differential between drive member pairs 14a and 14b may be such that drive member pair 14b is unable to advance the web due to the resistance produced by the idled power source for drive member pair 14a, which remain in contact with the web. As a result, drive member pair 14b exerts tension on the section of the web disposed between the drive member pairs 14a, b, which facilitates severance by severing mechanism 20. In addition, by continuing to supply power to drive member pair 14b after power to pair 14a has been halted, upon the severance of the web, drive member pair 14b will immediately propel the severed dunnage segment 44 out of machine 10 as shown in FIG. 3.

If additional dunnage segments 44 are required, power may again be supplied to drive member pair 14a, which pushes the leading edge 40 of the severed web 12 into the nip between the pair 14b of drive members, so that both pairs once again provide conveyance of web 12 through machine 10.

The operation of machine 10 may be controlled automatically, manually, or via a combination of both automatic and manual control. For instance, an electronic controller (not shown), may be employed to manipulate all functions of the machine. This controller can be a printed circuit assembly, e.g., with an EEPROM-type memory chip containing pre-programmed operating code for the machine, a programmable logic controller (PLC), or other such control device as commonly used in machines of the type to which the present invention pertains. Machine 10 may thus be fully and automatically controlled via the controller.

Alternatively, machine 10 may be controlled by a controller, but with operator intervention, e.g., manually via a foot pedal, hand switch, or other manually-actuatable device (not shown). An operator may thus be able to select the length and number of dunnage segments desired by appropriate input to the controller, e.g., via a control panel (not shown), or may choose to operate a foot pedal or other means to manually control the length and number of dunnage segments produced.

For example, in one mode of operation, a foot switch (not shown) may be provided for the operator of machine 10. When the foot switch is depressed, power is supplied both pairs of drive members 14a, b, causing the conveyance of web 12 through the machine. Once a suitable length of converted web has been produced, the operator may depress another switch, e.g., another foot switch, or the same foot switch again or, if spring loaded, simply reduce foot pressure on the switch. Through suitable programming of an associated controller, this may cause the following to occur: 1) stop the flow of power to drive member pair 14a, 2) maintain the flow of power to drive member pair 14b for a pre-determined additional period of time beyond the termination of power flow to drive member pair 14a, e.g., for five additional seconds, and 3) actuate the severing mechanism 20 through one cutting cycle. When the foot pedal or other switch is again depressed, the foregoing cycle is repeated.

Various alternative configurations may be practiced in accordance with the present invention. For example, instead of a single supply roll 22 and spool 24 associated with machine 10 as shown, two or more supply rolls/spools may be employed, e.g., with webs of different thickness, weight, density, etc. This would allow the operator of machine 10 to select a desired type of web when it is desired to produce dunnage segments having different levels of cushioning performance, e.g., when multiple items having different cushioning requirements are being packaged. Machine 10 may thus include two or more brackets to support the two or more supply rolls, or a supply cart having two or more brackets bearing two or more supply rolls could be moved into operational association with machine 10. As a further alternative, when employing two or more webs, e.g., from two or more supply rolls, two or more first web-shaping devices and two or more second web-shaping devices may be used. For example, if using two supply rolls containing two different webs, a first web-shaping device 16 and a second web-shaping device 18 could be associated with one supply roll while a separate set of first and second web-shaping devices 16,18 could be associated with the other supply roll, wherein both webs feed into the same conveyance mechanism 14, e.g., with one web entering the conveyance mechanism (after traveling through the first and second web-shaping devices) from above the conveyance mechanism and one entering from below (after traveling through a separate set of first and second web-shaping devices).

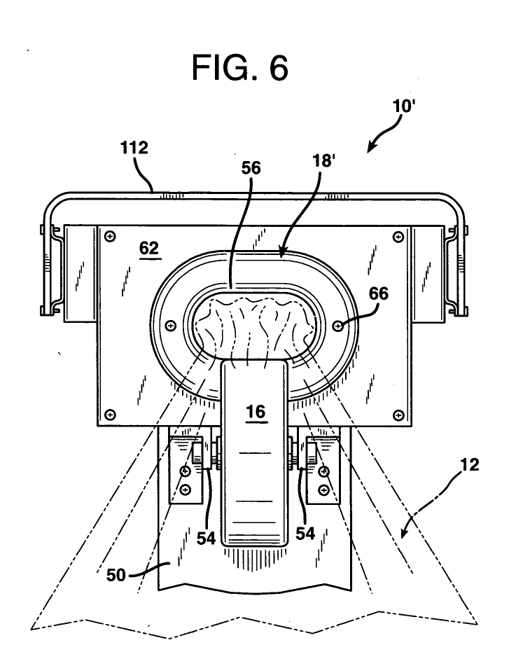

Referring now to FIGS. 5-9, a working embodiment of a machine in accordance with the present invention, designated 10′, will be described. Like components as previously described are designated with like reference numerals. Machine 10′ may include a support stand 50 (with a suitable base (not shown)), to which the working components of the machine may be mounted. A bracket 52 may be attached to stand 50, or may be independently supported; spool 24 and supply roll 22 of web 12 may be rotatably mounted on bracket 52. As shown in FIGS. 5-6, web 12 may thus be withdrawn from roll 22, crumpled by first web-shaping device 16, and further crumpled by second web-shaping device 18′.

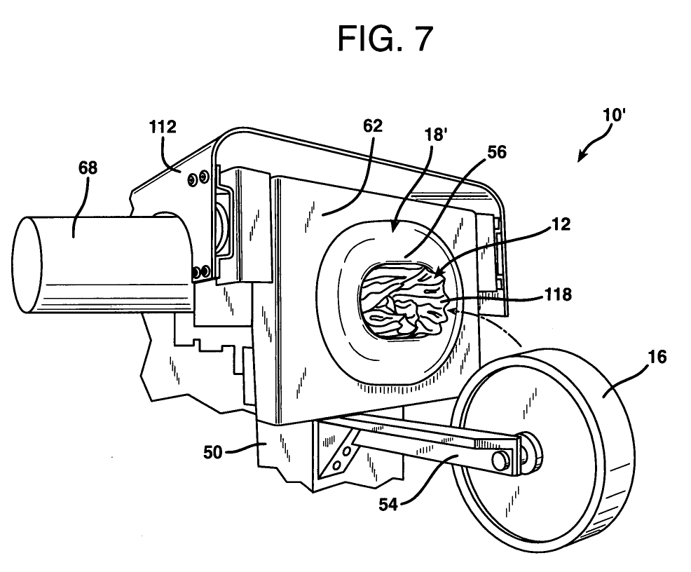

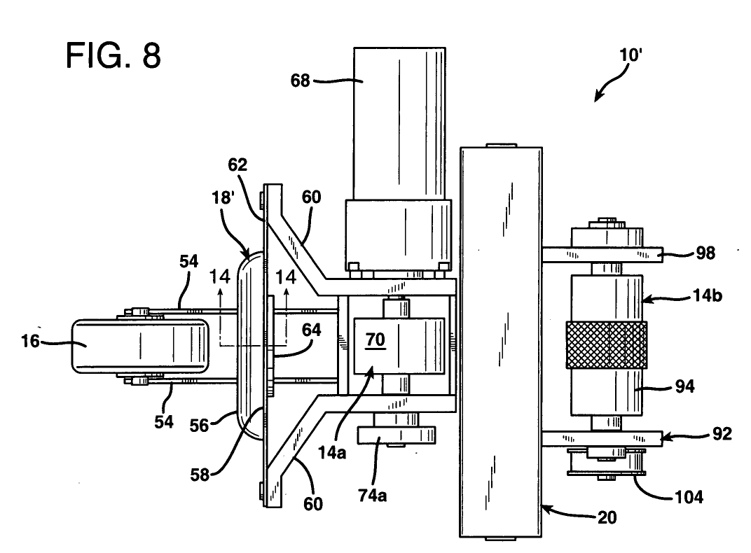

First web-shaping device 16 may, as shown, be a rotatable wheel, or a disk, roller, ball, etc., which rotates in the general direction of web travel when contacted by the web as it moves past the device. Alternatively, device 16 may be rotated by a power source, e.g., a motor, or may be a stationary device, such as a frame, bar, anvil, shoe, etc. The first web-shaping device 16 may be mounted, e.g., rotatably mounted, to stand 50, via brackets 54 as shown (see FIGS. 7-8).

The second web-shaping device may, as describe above, have a variety of shapes, e.g., a round toroid, an elliptical torroid, etc. In the present embodiment, second web-shaping device 18′ is generally in the shape of an elliptical torroid, as perhaps most clearly shown in FIGS. 5-7. The cross-sectional shape of device 18′ may be generally semi-circular, e.g., as shown in FIG. 11 (see also FIG. 8). Thus, second web-shaping device 18′ may be described as having a semi-toroidal shape with a curved, upstream-facing web-contact region 56 and a substantially non-curved, e.g., flat or angular, downstream-facing non-web-contact region 58.

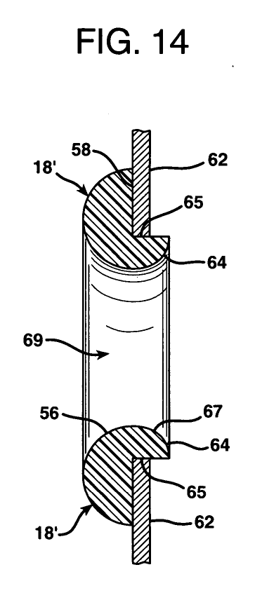

Machine 10′ may further include frame members 60 attached to support stand 50, to which some of the working components of machine 10′ may be mounted. For example, second web-shaping device 18′ may be attached to frame members 60 via mounting/cover plate 62. Attachment of the second web-shaping device 18′ to mounting plate 62 may be facilitated by including in device 18′ an annular exit section 64, which may extend from the otherwise flat, downstream-facing region 58. As indicated in FIG. 8, and shown perhaps most clearly in FIG. 14, the exit section 64 may be inserted through an orifice 65 in mounting plate 62, thereby fixing the placement of device 18′ on plate 62. Exit section 64 may also be useful to prevent web 12 from contacting orifice 65 in mounting plate 62, which could result in the tearing of the web. Exit section 64 may thus include a curved, web-facing region 67, which may (1) merge with and/or constitute part of web-contact region 56, and (2) border web-passage 69 in second web-shaping device 18′ (FIG. 14).

Web-shaping device 18′ may be secured in place on plate 62 via suitable fasteners, e.g., screws 66 (FIG. 6).

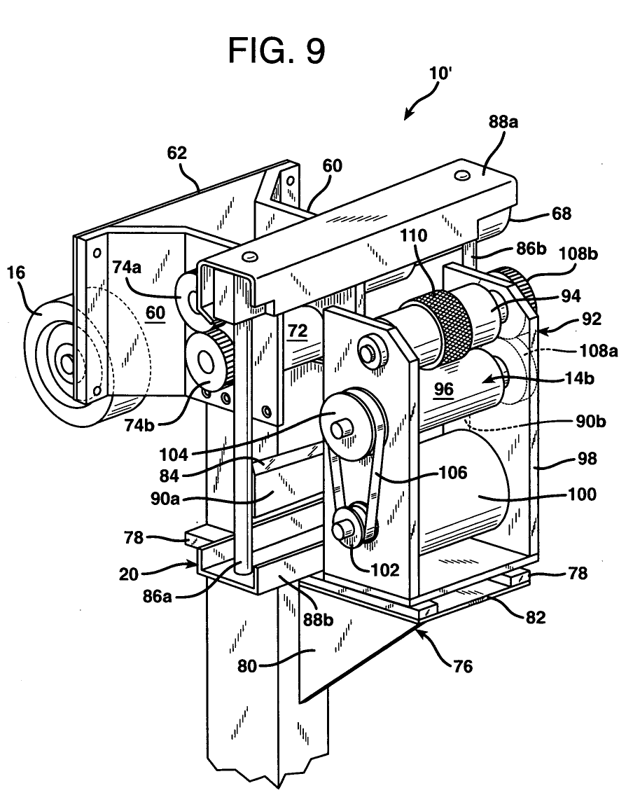

As shown in FIGS. 8-9, frame members 60 may also be used to rotatably support the first drive-member pair 14a. A motor 68 may be used to power the rotation of the drive member pair 14a, which may be mounted to one of the frame members 60 as shown. Motor 68 may be directly coupled to one of the drive members, e.g., to upper drive member 70 as shown. Rotation of the other (e.g., lower) drive member 72 may be accomplished by linking the rotation of the two drive members, e.g., via gears 74a and 74b.

Severing mechanism 20 may also be mounted to support stand 50, e.g., via mounting assembly 76, which may include mounting rails 78, angle bracket 80, and platform 82 (see FIG. 9). In the illustrated embodiment, severing mechanism 20 is a vertically-oriented, ‘guillotine-type’ cutting device, including a translatable blade 84, a pair of guide cylinders 86a, b, and upper and lower frame members 88a, b. When it is desired to sever web 12, blade 84 may be caused to translate in an upward direction from the ‘resting’ position shown in FIG. 9, i.e., near lower frame member 88b, whereupon the blade cuts through the web as it moves towards upper frame member 88a. Movement of blade 84 may be effected by any suitable conveyance means, e.g., a pair of pneumatically or hydraulically actuated pistons (not shown), each of which may travel inside of one of the guide cylinders 86a, b and may be attached to one of the ends 90a, b of blade 84. Alternative means of conveyance may also be employed, such as a mechanical, electrical, and/or magnetic system, including combinations of any or all of the foregoing with pneumatic or hydraulic systems.

Machine 10′ may further include an exit assembly 92, which may be supported on stand 50 by mounting assembly 76 as shown in FIG. 9. In the embodiment illustrated, exit assembly 92 contains the second drive-member pair 14b, which may include upper and lower drive members 94 and 96, respectively. The drive member pair 14b may be rotatively supported by a frame 98, which rests on mounting assembly 76 as shown. The counter-rotation of upper and lower drive members 94, 96 may be powered by motor 100, which may be supported by frame 98. In the embodiment illustrated, the rotational output of motor 100 is linked to lower drive member 96 via pulleys 102,104 and drive belt 106. The rotation of lower drive member 96 may, in turn, be linked to that of upper drive member 94 via intermeshing gears 108a, b. If desired, upper drive member 94 may have a fully or, as shown, partially knurled surface 110, which may facilitate guiding the leading edge 40 of severed web 12 (see FIG. 3) between the upper and lower drive rollers 94, 96 following the severance of the web.

Referring back to FIGS. 5-7, one or more outer covers may be included on machine 10′, including top cover 112, severing mechanism cover 114, and exit assembly cover 116. Such covers may be useful to provide both a safety function, i.e., to prevent accidental contact with the working components of machine 10′, and an aesthetically pleasing appearance.

FIG. 7 shows the trailing edge 118 of web 12 in a crumpled state in second web-shaping member 18′, i.e., after depletion of supply roll 22, and thus illustrates one crumple pattern that may achieved with machine 10′. Additional dunnage material may once again be produced by simply supplanting the depleted supply roll with a new supply roll on bracket 52, folding the web around the first web-shaping device 16, stuffing the leading edge of the web into the second web-shaping device 18′, and then urging the leading edge of the web against the first pair 14a of drive members as the drive members rotate.

The foregoing description of preferred embodiments of the invention has been presented for purposes of illustration and description. It is not intended to be exhaustive or to limit the invention to the precise form disclosed, and modifications and variations are possible in light of the above teachings or may be acquired from practice of the invention.

What is claimed is:

1. A machine for converting a web of material into dunnage, said machine comprising:
a) a mechanism for conveying the web through said machine;
b) a first web-shaping device for crumpling the web;
c) a second web-shaping device for further crumpling the web, said second web-shaping device comprising a three-dimensional, annular member having a passage therein through which the web may travel, said annular structure having a web-contact region bordering said passage, said web-contact region comprising a curved surface and providing sliding contact with the web to effect the further crumpling thereof; and
d) a severing mechanism to sever the web into discrete lengths.

2. The web conversion machine of claim 1, wherein said first web-shaping device is positioned upstream of second web-shaping device.

3. The web conversion machine of claim 1, wherein said first web-shaping device causes the web to at least partially fold upon itself.

4. The web conversion machine of claim 1, wherein the web moves through said machine along a defined path of travel, said first web-shaping device causing the web to change direction along its travel path.

5. The web conversion machine of claim 4, wherein said first web-shaping device causes the web to change from a generally vertical direction of movement to a generally horizontal direction of movement.

6. The web conversion machine of claim 1, wherein said second web-shaping device has a substantially toroidal shape.

7. The web conversion machine of claim 6, wherein said second web-shaping device has a substantially round toroidal shape.

8. The web conversion machine of claim 6, wherein said second web-shaping device has a substantially elliptical toroidal shape.

9. The web conversion machine of claim 6, wherein said second web-shaping device has a semi-toroidal shape with a curved, upstream-facing web-contact region and a substantially non-curved, downstream-facing, non-web-contact region.

10. The web conversion machine of claim 1, wherein said second web-shaping device has a cross-sectional shape selected from circular, semi-circular, elliptical, semi-elliptical, and combinations thereof.

11. The web conversion machine of claim 1, wherein said conveyance mechanism comprises at least a first pair of counter-rotating drive members.

12. The web conversion machine of claim 11, wherein said conveyance mechanism further includes at least a second pair of counter-rotating drive members positioned downstream of said first pair of drive members.

13. The web conversion machine of claim 12, wherein said severing mechanism is positioned between said first and second pairs of drive members.

14. The web conversion machine of claim 1, wherein said machine further comprises an exit chute.

15. The web conversion machine of claim 14, wherein the web moves through said machine along a defined path of travel, said exit chute causing the web to change direction along its travel path.

16. The web conversion machine of claim 15, wherein said exit chute causes the web to change from a generally horizontal direction of movement to a generally vertical direction of movement.

17. A machine for converting a web of material into dunnage, said machine comprising:
a) a mechanism for conveying the web through said machine;
b) a first web-shaping device for crumpling the web;
c) a second web-shaping device for further crumpling the web, said second web-shaping device comprising a generally toroidal-shaped structure having a passage therein through which the web may travel, said generally toriodal-shaped structure having a web-contact region bordering said passage, said web-contact region providing sliding contact with the web to effect the further crumpling thereof; and
d) a severing mechanism to sever the web into discrete lengths.

18. A method for converting a web of material into dunnage, said method comprising:
a) crumpling the web in a first web-shaping device;
b) further crumpling the web in a second web-shaping device, said second web-shaping device comprising a three-dimensional, annular structure having a passage therein through which the web may travel, said annular structure having a web-contact region bordering said passage, said web-contact region comprising a curved surface to provide sliding contact with the web to effect the further crumpling thereof;
c) conveying the web through said first and second web-shaping devices; and
d) severing the web into discrete lengths.
